(19) United States
(12) Patent Application Publication
(10) Pub. No.: US 2024/0249198 A1
(43) Pub. Date: Jul. 25, 2024

(54) SYSTEMS AND METHODS FOR REAL-TIME REINFORCEMENT LEARNING

(71) Applicant: AI Redefined Inc., Montreal (CA)

(72) Inventor: François Chabot, Montreal (CA)

(21) Appl. No.: 18/562,178

(22) PCT Filed: May 18, 2022
(86) PCT No.: PCT/CA2022/050786

§ 371 Date: Nov. 17, 2023

Related U.S. Application Data
(60) Provisional application No. 63/191,203, filed on May 20, 2021.

(51) Int. Cl. G06N 20/00

(52) U.S. Cl. CPC G06N 20/00

(57) ABSTRACT

Systems and methods for deferring aggregation of rewards while maintaining live-learning capabilities in reinforcement learning are described. The method provides for retroactive rewards from human operators to be available to online learning processes without requiring learning processes to be substantially altered, while minimizing the use of fast-access computer memory. The method makes use of a sliding-time window where retroactive rewards are accumulated before being dispatched to corresponding learning agents when time-points fall out of the window.

### CROSS-REFERENCE TO RELATED APPLICATION

The present application claims priority to U.S. Provisional Patent Application No. 63/191,203, which was filed May 20, 2021, the content of which is incorporated herein by reference in its entirety.

### FIELD

The present disclosure relates generally to human-in-the-loop (HITL) machine learning, a branch of artificial intelligence (AI). More specifically, the present disclosure relates to means for managing and distributing reward information to learning agents during real-time HITL sessions.

### INTRODUCTION

Human-in-the-loop (HITL) modelling and simulation includes a number of different learning methods and roles for the aforementioned humans in the learning loop. One aspect of some HITL modelling and simulation relies on one or more humans, acting as evaluators, giving feedback to learning agents in real-time. Learning agents are entities that, over time, improve their performance at accomplishing tasks through interaction with an environment. Learning agents can thus use human evaluator feedback to update their policy so as to maximize the accumulation of positive human feedback (e.g., positive “rewards”) and/or to minimize the accumulation of negative human feedback (e.g., negative “rewards”). A learning agent's policy can be considered as the parametrized logic used by the agent to choose actions based on its perception of the environment. Collectively, these scenarios can be referred to as live human-in-the-loop reinforcement learning (RL).

In this context, providing a HITL environment where learning agents can continuously learn from real-time feedback in an online learning session enables the learning agents to accelerate the processes of optimizing their policies by exploring their action spaces faster, thus accelerating the overall learning process. In a HITL RL system, human feedback requires a human evaluator to process and evaluate a learning agent's ability to reach a goal and to assign rewards in response thereto.

One of the technical problems associated with HITL RL systems is known as the “credit assignment problem”, which relates to how a system can effectively assign rewards to the achievement of a goal, when the goal is achieved by a sequential series of actions. Some prior art systems and methods for solving this problem include allowing human evaluators to provide rewards for “offline learning” (i.e., after a learning session has ended). Other prior art methods of solving this problem include the assignment of rewards to specific learning agent actions. In such systems, once a human evaluator assesses an action by the learning agent, the system allows the human evaluator to input a reward associated with the action. The association of the reward with the action can be done using any number of known methods. For example, the system may provide a human evaluator with a User Interface (UI) which lists actions taken by the learning agent and allows the human evaluator to select a reward in response to each action. As will be appreciated by the skilled reader however, other methods of associating a reward with an action taken by a learning agent are possible.

Once a reward is received by the HITL RL system, the system communicates that reward to the appropriate learning agent (e.g., the learning agent that took the action associated with the reward), together with an indication of the action for which the reward was generated. In HITL RL systems, because received rewards can have immediate effects on the policy (and therefore decisions) of a learning agent, subsequent actions can be influenced by whether or not a reward has been received and processes by the learning agent for a specific action, and what that reward was (e.g., positive or negative). A learning agent's policy will be optimized more quickly by providing the learning agent with rewards as quickly as possible during an online learning session, so that each reward can be taken into consideration as early on as possible in the series of actions taken by the learning agent during an online learning session. Such real-time learning provides a significant technical advantage over offline learning (i.e., providing a number of stored rewards to learning agents after an online learning session ends), but is predicated on the ability of a system to provide accurate reward information to agents in a timely manner.

One technical problem associated with the above HITL RL systems is that human reaction times can introduce a significant delay between a learning agent taking an action, and the learning agent receiving human feedback on the action.

In order to address some of these problems, prior art systems have been developed that assume fixed time intervals between receipt of a reward and actions taken, so that, for example, rewards received at time t are associated with action taken at time t−x. These prior art systems however are disadvantageous because they assume a fixed reaction time on the part of the human evaluator. This disadvantage is compounded when such systems are used in learning sessions where multiple human evaluators are providing rewards in relation to a specific action. In such session, multiple rewards relating to a single action can be received at various times from various human evaluators, each having their own reaction time. The cumulative effect of each of the rewards received on the policy of the learning agent will therefore not be known until the last reward is received. Moreover, in such sessions, the system may need to process a large number of streams of rewards, in which rewards are not necessarily received in temporal order.

There is thus a need to provide systems and methods for real-time (i.e., online) reinforcement learning that provide solutions to at least the above technical problems.

### SUMMARY

The following summary is intended to introduce the reader to the more detailed description that follows, and not to define or limit the claimed subject matter.

The present disclosure generally relates to systems and methods for collecting and consolidated retroactive rewards in a distributed multi-agent reinforcement-type machine learning environment.

According to one aspect of the present disclosure, there is provided a computer implemented method for processing rewards received during a reinforcement learning session in which one or more learning agents each perform one or more actions in a reinforcement-type machine learning environment. Each reward is associated with an action. The method comprises the step of setting a fixed length sliding window within which past actions are considered. The method also comprises the step of receiving a plurality of rewards, each reward being associated with an action taken by a learning agent. The method also comprises the step of defining a group of in-window rewards comprising rewards received while their associated actions are considered to be within the fixed length sliding window. The method also comprises the step of, when an action performed by a learning agent is no longer considered to be within the fixed length sliding window, sending the learning agent reward information relating to all in-window rewards received for the action.

According to another aspect of the present disclosure, there is provided a system for processing rewards received during a reinforcement learning session in which one or more learning agents each perform one or more actions in a reinforcement-type machine learning environment. Each reward is associated with an action. The system comprising a processor. The system also comprises at least one non-transitory memory containing instructions which when executed by the processor cause the system to set a fixed length sliding window within which past actions are considered. The instructions also cause the processor to receive a plurality of rewards, each reward being associated with an action taken by a learning agent. The instructions also cause the processor to define a group of in-window rewards comprising rewards received while their associated actions are considered to be within the fixed length sliding window. The instructions also cause the processor to, when an action performed by a learning agent is no longer considered to be within the fixed length sliding window, send the learning agent reward information relating to all in-window rewards received for the action.

The systems and methods described herein provide, inter alia, technical advantages associated with efficiently, effectively and flexibly processing retroactive rewards from human operators to be available to online learning processes without requiring those learning processes to be substantially altered, while minimizing the use of fast-access computer memory.

Additional technical features and benefits are realized through the techniques of the present invention. Embodiments and aspects of the invention are described in detail herein and are considered a part of the claimed subject matter. For a better understanding, refer to the detailed description and to the drawings.

### DRAWINGS

In order that the claimed subject matter may be more fully understood, reference will be made to the accompanying drawings, in which:

FIG. 1 shows a schematic bloc diagram of a distributed multi-agent learning environment in accordance with embodiments of the present disclosure;

FIG. 2 shows flow-chart of a method for collecting rewards in accordance with embodiments of the present disclosure;

FIG. 3 shows flow-chart of a method for consolidating rewards in accordance with embodiments of the present disclosure; and

FIGS. 4A to 4D show timing diagrams relating to the methods of FIGS. 2 & 3.

### DESCRIPTION OF VARIOUS EMBODIMENTS

It will be appreciated that, for simplicity and clarity of illustration, where considered appropriate, reference numerals may be repeated among the figures to indicate corresponding or analogous elements or steps. Numerous specific details are set forth in order to provide a thorough understanding of the exemplary embodiments of the subject matter described herein.

However, it will be understood by those of ordinary skill in the art that the embodiments described herein may be practiced without these specific details. In other instances, well-known methods, procedures and components have not been described in detail so as not to obscure the present subject matter. Furthermore, this description is not to be considered as limiting the scope of the subject matter in any way but rather as illustrating the various embodiments.

Additionally, any examples set forth in this specification are not intended to be limiting and merely set forth some of the many possible embodiments for the claimed invention. Moreover, the various tasks and process steps described herein can be incorporated into a more comprehensive procedure or process having additional steps or functionality not described in detail herein. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. As used herein, the terms “comprises,” “comprising,” “includes,” “including,” “has,” “having,” “contains” or “containing,” or any other variation thereof, are intended to cover a non-exclusive inclusion. For example, a process, method or system that comprises a list of elements is not necessarily limited to only those elements but can include other elements not expressly listed or inherent to such, process, method or system.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship.

Additionally, variations in the arrangement and type of the components illustrated in the various figures of this disclosure may be made without departing from the spirit or scope of the invention.

Briefly stated, certain embodiments of the present disclosure are related to methods and systems for deferring aggregation of rewards in HITL environment, enabling the objectives of maintaining live-learning capabilities, automating the human reward attribution, scaling up the size of the HITL environment, and reducing need for fast-access computer memory.

As used herein, the term “HITL” refers to human-in-the-loop machine learning that requires interaction.

As used herein, the term “learning agent” refers to an artificial intelligence entity that can, over time, improve its performance in performing a task or tasks based on its interactions with an environment and/or rewards received from human evaluators, other learning agents and/or the environment.

As used herein, the term “policy” refers to the parametrized logic used by a learning agent to choose actions based on its observation of an environment and the learning agent's internal state.

As used herein, the term “RL” refers to reinforcement learning.

As used herein, the term “environment” refers to a computer-generated environment and/or a real-world environment.

As used herein, the term “simulation” refers to a computer-generated environment which is configured to simulate one or more aspects of a real-world environment.

As used herein, the term “time” can refer to real time or to sequential discrete timestep intervals through which a simulation or a computer-generated environment will progress.

As used herein, the term “learning session” refers to a period of time during which learning agents interact with an environment and/or simulation in order to update their policies.

As used herein, the term “offline learning” refers to the action of updating a policy, outside of a learning session, by analyzing a database of historical data.

As used herein, the terms “online learning” or “live learning” refers to the action of updating a policy, during a learning session, by analyzing data received from an environment, a simulation, one or more other learning agents and/or one or more human evaluators.

As used herein, the term “reward” refers to any information received by a learning agent from the environment, one or more other learning agents and/or one or more human evaluators in response to the agent's performance of a task or action during a learning session. Rewards can include a numerical value representing the positive, negative or neutral assessment of the task or action associated with the reward. Rewards can also include metadata associated with the rewards. Such metadata can include, but is not limited to, information relating to the entity sending or generating a reward and weighting information relating to a relative importance of a reward with respect to other rewards. As will be appreciated, metadata can also be used by learning agents to update their policies.

As used herein, the term “instantaneous reward” refers to a reward that is received for a given action in a learning session, if the reward is received prior to performance of the next action in the learning session following the given action.

As used herein, the term “retroactive reward” refers to any reward that is associated with a specific action that occurred in the past.

As used herein, the term “fixed length sliding window” refers to any hardware and/or software element that allows for an indefinite amount of data in a data stream to be considered for a fixed period of time, or for a fixed amount of cyclically buffered data in a data stream to be considered for an indefinite amount of time.

As used herein, the term “in-window reward” refers to any reward received for an action while the action is within the fixed length sliding window.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

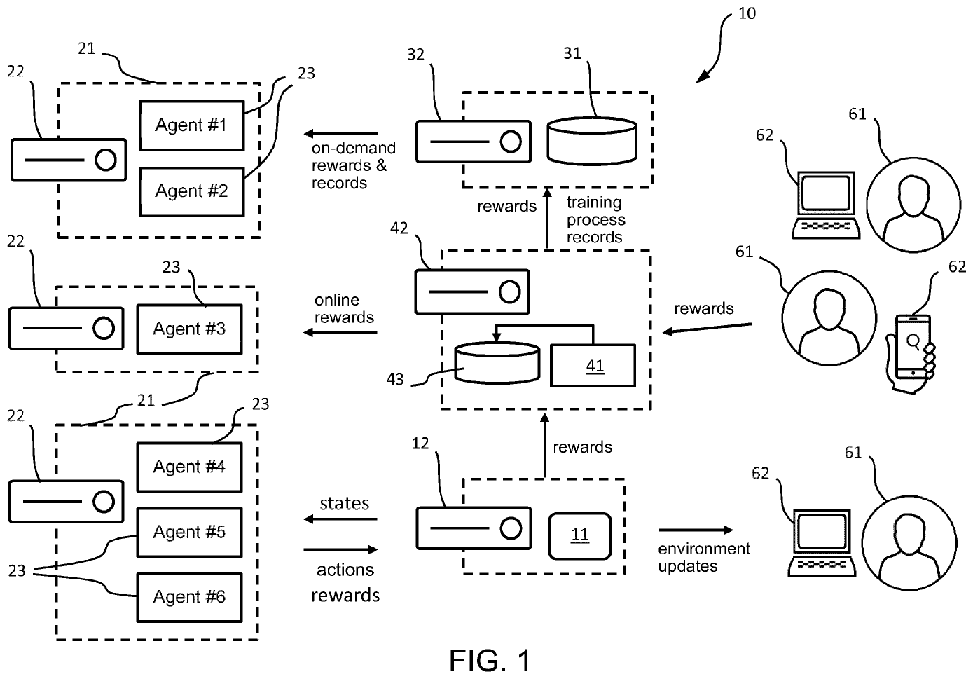

FIG. 1 shows an exemplary system in accordance with embodiments of the present disclosure. In particular, FIG. 1 shows a distributed multi-agent learning system 10 comprising a learning environment 11 located on environment server 12, one or more agent services 21 comprising an agent server 22 hosting one or more agents 23, an offline database 31 located on server 32, a proxy 41 located on proxy server 42 and in data communication with online database 43, and one or more human evaluators 61, each operating a computing device 62.

The various elements of the distributed multi-agent learning system 10 can be interconnected using any suitable data wired or wireless data communication means and may be provided through the use of dedicated hardware as well as hardware capable of executing software in association with appropriate software. The distributed multi-agent learning system 10 may also include one or more communication components (not shown) configured to allow the distributed multi-agent learning system 10 to communicate with a data communications network such as the Internet, and communication thereto/therefrom can be provided over a wired connection and/or a wireless connection.

In particular, each of the environment server 12, agent servers 22, server 32, proxy server 42 and computing devices 62 are networked computers connecting remotely to one another and typically installed with computational means comprising a hardware processor, memory, optional input/output devices, and data communications means. For example, and without limitation, each of environment server 12, agent servers 22, server 32, proxy server 42 may be a programmable logic unit, a mainframe computer, a server, a personal computer, a cloud-based program or system. Computing devices 62 may be a personal computer, a smartphone, a smart watch or a tablet device or any combination of the foregoing.

The aforementioned hardware processors may be implemented in hardware or software, or a combination of both. They may be implemented on a programmable processing device, such as a microprocessor or microcontroller, a Central Processing Unit (CPU), a Digital Signal Processor (DSP), a Field Programmable Gate Array (FPGA), general purpose processor, and the like. The hardware processors can be coupled to memory means, which store instructions used to execute software programs, including learning environment 11, off-line database 31, proxy 41 and database 43. Memory can include non-transitory storage media, both volatile and non-volatile, including but not limited to, random access memory (RAM), dynamic random-access memory (DRAM), static random-access memory (SRAM), read-only memory (ROM), programmable read-only memory (PROM), erasable programmable read-only memory (EPROM), electrically erasable programmable read-only memory (EEPROM), flash memory, magnetic media, or optical media. Communications mean can include a wireless radio communication modem such as a Wi-Fi modem and/or means to connect to a local area network (LAN) or a wide area network (WAN).

Environment server 12, agent servers 22, server 32 and proxy server 42 can be located remotely and in data communication via, for example, the Internet, or located proximally and in data communication via, for example, a LAN. Computing devices 62 can connect to proxy server 42 remotely or locally. In some embodiments, server 12, agent servers 22, server 32 and proxy server 42 can be implemented, for example, in a cloud-based computing environment, by virtual machines or containers or by a single computer or a group of computers. In some embodiments, learning environment 11, as well as any software applications and data related thereto can distributed between environment server 12, agent server 22, server 32, proxy server 42 and computing device 62, for example, using a Cloud-based distribution platform.

Learning environment 11, which can be implemented on environment server 12, is a computer program that provides a simulated environment characterized by an interface between a user, or a user and an agent, and the system to be experimentally studied, and which performs tasks including description, modelling, experimentation, knowledge handling, evaluating and reporting. The learning environment 11 is the manifestation of the situation in which agents are to accomplish a task and includes all of the logical relationships and rules required to resolve how the learning agents and the environment can interact. The learning environment 11 provides states, which are representations of a state at a certain time step within the environment. Such states can be perceived by agents through sensors or may be directly provided by the learning environment. A learning agent can perceive a state, or part thereof, and form an observation thereon. An observation can therefore be in respect to a simulation, task, procedure, event or part thereof, and may be specific to a learning agent's 23 perspective on a state of an environment. The learning agents 23 are configured to produce actions in response to observations and are presented with rewards according to the impact those actions have or had on the learning environment 11 and/or on other learning agents 23.

Each software application is preferably implemented in a high-level procedural or object-oriented programming and/or scripting language to communicate with a computer system. Alternatively, the software applications can be implemented in assembly or machine language, if desired. In either case, language may be a compiled or interpreted language. Each such software application on environment server 12, agent server 22, server 32, proxy server 42 and computing device 62, referred to collectively as a system, is preferably stored on memory means and readable by a hardware processor for configuring and operating the system when memory is read by the hardware processor to perform the procedures described herein.

According to an embodiment of the present disclosure, the learning environment 11 is configured to send states to learning agents 23 and to receive actions from agents 23. The tasks performed by a first learning agent 23 can be evaluated by the learning environment 11, by one or more other learning agents 23 and/or by one or more human evaluators 61. Each of the learning environment 11, one or more other learning agents 23 and/or one or more other human evaluators 61 can generate, and provide the first learning agent 23 with, appropriate rewards based on their respective evaluations. Each reward can refer to an action performed by the learning agent 23 either in real-time, or in the past. In particular, human evaluators 61 have the capacity to attribute rewards relating to the performance by a learning agent 23 of past actions. The learning environment 11 thus evolves overtime as a result of sequential states, observations and actions of learning agents 23.

As will be appreciated by the skilled reader, the learning environment 11 can be implemented either online or offline. In some embodiments, proxy 41 can be implemented in such a way as to collect rewards during a learning session and provide the rewards to learning agents 23 once the learning session has ended (i.e., an offline implementation), as described in more detail herein. Alternatively, or in addition, proxy 41 can be implemented in such a way as to collect and send rewards to learning agents 23 during a learning session (i.e., an online, or real-time, implementation). In some embodiments, proxy 41 is configured to collect, aggregate, and send rewards to learning agents 23 in accordance with the methods described herein. As will also be appreciated by the skilled reader, the use of retroactive rewards in online learning can mitigate the benefits thereof, as agents can perform a sequence of tasks without receiving rewards in respect of previous tasks. As such, the use of retroactive rewards in online reinforcement learning sessions can lead to delays in agent policies converging towards optimal solutions. Moreover, some online learning implementations (e.g., long short-term memory recurrent neural network implementations), require rewards to be received sequentially. Accordingly, any retroactive rewards that are received out of sequence by such implementations cannot be processed. As will be appreciated, this problem is aggravated by having to receive rewards from large numbers of human evaluators having different reaction times.

According to an exemplary embodiment of the present disclosure, proxy 41 manages the flow of rewards between each of agent servers 22, server 32 and computing devices 62. In particular, proxy 41 receives rewards from computing devices 62, each controlled by a human evaluator 61 and transmits rewards to one or more learning agents 23. Proxy 41 also provides reward and learning process information to server 32 for storage on offline database 31, from which server 32 can provide rewards and learning process records to one or more learning agents 23 on-demand. In some embodiments, learning process records can include, but are not necessarily limited to, agent observation information, agent action information and agent reward information.

Human evaluators 61 are provided with access to the simulation environment by way of computing devices 62. The learning environment 11 can update the simulation environment either in real-time on a continuous basis, or using a calendar or event-based process, such events including, but not limited to, the end of a learning session or the start of a new learning session.

In an example of embodiments in accordance with the present disclosure, the learning environment 11 can implement a flight simulation environment in which a learning agent 23 trains to pilot a drone, where one or more tasks assigned to learning agent 23 is to determine the location of forest fires in the simulation. In the example, a human evaluator 61 can also pilot a helicopter simulation with a view to accomplishing the same task. The learning environment 11 can provide rewards to agents relating to how well the learning agent 23 and human evaluator 61 pairings are performing.

The learning environment 11 creates a high volume of data in real-time and the system 10 sends reward information to learning agents 23 as it is being generated, in order for learning agent 23 to learn to pilot the drone and to perform the task as quickly as possible. The human operator 61 (who may be well-trained in the task), can provide expert knowledge to the system 10 by providing rewards to learning agent 23 based on the performance of learning agent 23 at performing specific actions. As such, learning agents 23 can receive rewards from human evaluators 61, via computing devices 62 and proxy 41. In the present example, human evaluator 61 rewards can take various forms, including without limitation, the human evaluator 61 providing positive or negative rewards in response to a flight path, elevation, speed or direction of the drone piloted by learning agent 23. Integration of rewards received from human evaluator 61 in the learning process accelerates the speed at which learning agent 23 identifies actions having positive outcomes (i.e., receiving rewards), and thus accelerates the learning speed of one or more agents 23.

In the present example, the reaction time within which human evaluator 61 can produce a reward after evaluating the performance of learning agent 23 will depend on the reaction speed and availability of human evaluator 61, who in this example is also preoccupied with the piloting of a helicopter simulation. Accordingly, the cognitive and physical reaction time of human evaluator 61 may be further delayed by distraction, though any and all rewards can still be associated with an action performed by learning agent 23.

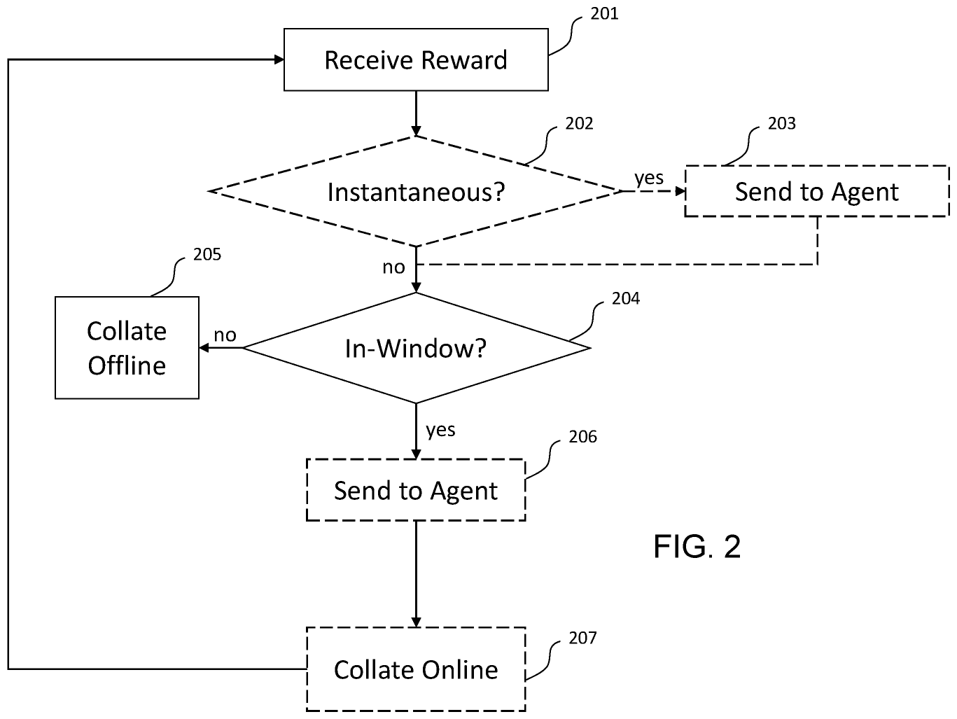

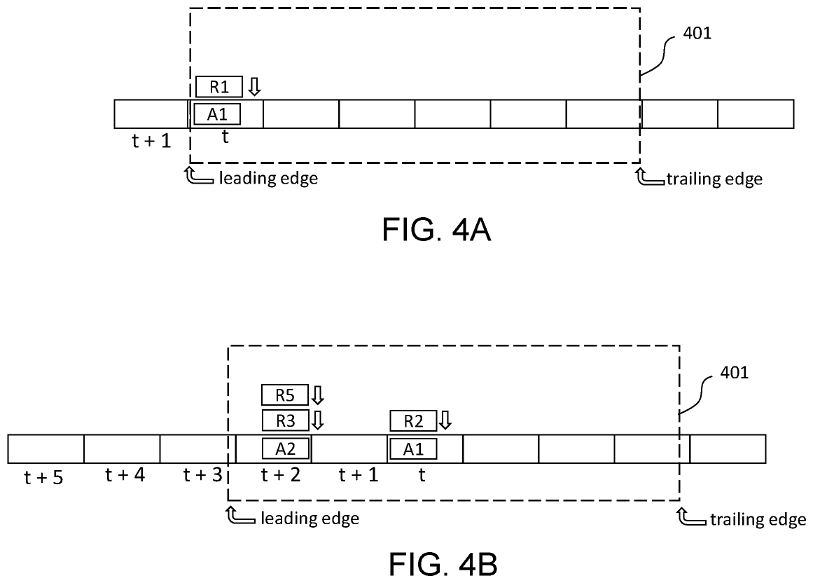

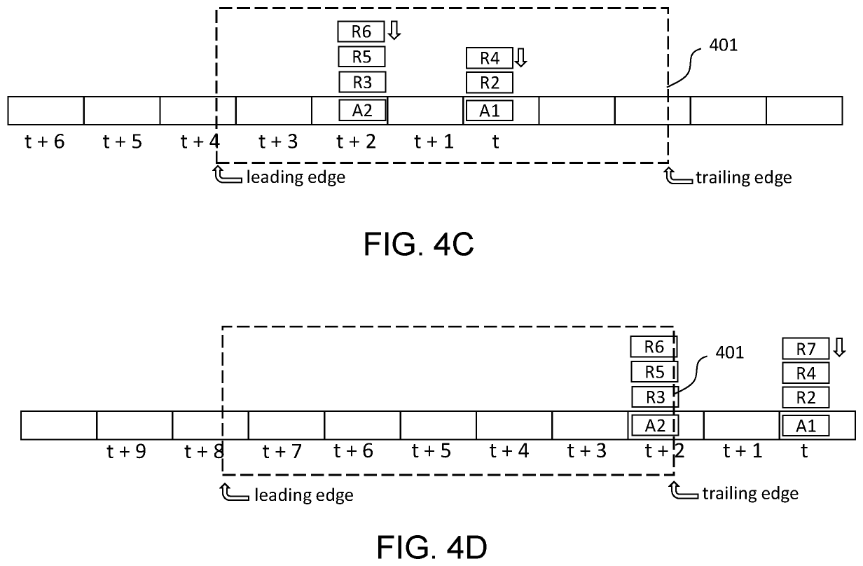

With reference to FIGS. 2 and 4A to 4D, an example of a method for processing retroactive rewards from one or more human evaluators 61 during live learning sessions in accordance with the present disclosure will now be described.

As shown, in FIGS. 4A to 4D, the system 10 sets a fixed length sliding window 401 including a leading edge and a trailing edge. As will be appreciated, in other embodiments, a user of the system 10 may set the length of the fixed length sliding window 401. As shown in the timing diagrams of FIGS. 4A to 4D, rewards Rx associated to actions Ax can be received at any time (i.e., at any time after the leading edge of the fixed length sliding window). As such, rewards Rx received from one or more human evaluators 61 and relating to one or more actions Ax performed by one or more agents can either be received when an action Ax is within the fixed length sliding window 401 (i.e., between the leading edge and the trailing edge) or outside of the fixed length sliding window 401 (i.e., after the trailing edge).

This fixed length sliding window 401 can be implemented as a timer (e.g., in reference to a duration typically expressed as a length in seconds), or on a discrete “step” basis (e.g., with reference to a number of simulation steps, or with respect to a certain level of progression of the learning environment 11, characterized for example by the performance of a given task by an agent 23). In accordance with some embodiments, the learning environment 11 can make use of a monotonic clock. In such instances, it will be appreciated that the time-defined duration and the step-defined duration are equivalent, since there is a fixed relationship between the simulation step and the simulation time. When the learning environment 11 makes use of a real-time Δt, the time-defined duration and the step defined duration may be different durations.

While the embodiments shown in FIGS. 4A to 4D show a fixed length sliding window 401 implemented as a timer, it will be appreciated that in other embodiments, the fixed length sliding window 401 can be implemented as a hardware and/or software-based memory circular buffer in which only a fixed number of actions in a sequence of actions in the learning session are considered to be in the fixed length sliding window 401 at any point in time.

As noted above, when a learning agent 23 performs an action Ax, rewards associated with that action may be received. As described in more detail herein, rewards may be received from human evaluators 61, other learning agents 23 and/or learning environment 11. In some embodiments, a reward may be a value comprised within a group including a positive reward, a negative reward, zero, or void. The zero, positive and negative rewards can convey a critical assessment of the action Ax performed by a particular learning agent 23. In some embodiments, the critical assessment can relate to an objective (e.g., whether the action brings the agent 23 closer to—or takes them farther from—achieving a given objective). In some embodiments, a positive reward can relate to a degree of success, and a negative reward can relate to a degree of failure, and a reward having a zero value may be neutral. In some embodiments, a void reward can indicate the absence of a reward.

In some examples, a single reward Rx can be received for a single action Ax. In other examples, multiple rewards Rx can be received for a single action Ax. Moreover, multiple rewards Rx may be received from one or more human evaluators 61, other learning agents 23 and/or learning environment 11 for a single action. In some embodiments, rewards Rx received from one or more human evaluators 61 may be weighted differently to rewards Rx received from one or more other human evaluators 61, one or more learning agents 23 and/or learning environment 11. Weighting rewards RX allows for the system 10 to provide a mechanism by which some rewards have a greater impact on an agent's policy than other rewards, the advantages of which mechanism will be understood by the skilled reader.

FIG. 2 shows flow-chart of a method for collecting rewards in accordance with embodiments of the present disclosure. As shown in FIG. 2, at step 201, a reward is received by the system 10. In some embodiments, the system 10 may determine whether the received reward is an instantaneous reward at step 202, meaning whether or not the reward was received prior to performance of the next action in the learning session. In such embodiments, the system 10 may send any and all instantaneous rewards immediately to the appropriate learning agent 23 at step 203. Typically, instantaneous rewards will be generated by learning environment 11 or other learning agents 23, as human evaluators 61 do not have sufficiently fast reaction times to generate instantaneous rewards.

In other embodiments, after a reward is received at step 201, a determination is made as to whether the reward has been received for an action that is considered to be within the fixed length sliding window 401 at step 204 (i.e., whether the reward received is an in-window reward). As shown in FIGS. 4A to 4D, reward R1 received at time t, rewards R5, R3 and R2 received at time t+3, rewards R6 and R4 received at time t+4 would all be considered to be “in-window rewards”. As shown in FIG. 4D however, reward R7 would be considered to be a retroactive reward, but not an in-window reward, as it was received in respect of an action (i.e., A1) that had left the fixed length sliding window 401 by the time (i.e., t+8) R7 was received. As described in more detail herein, the fixed length sliding window 401 can be implemented as a timer, and the time at which a reward is received (indicated by a downward-pointing arrow in FIGS. 4A to 4D) can determined by using, for example, a timestamp provided by the system 10.

At step 205, any retroactive rewards that are not considered to be in-window rewards are sent to memory for offline learning. As such, once an online training session ends, retroactive rewards that are not considered to be in-window rewards can be sent to the agent for offline learning. As shown in FIG. 2, the method is repeated for each reward received during the online learning session.

In some embodiments, at step 206, in-window rewards are immediately sent to the appropriate agent 23 for online learning. In an example of such embodiments applied to the situation shown in FIGS. 4A to 4D, as soon as rewards R1, R2, R5, R4, R4, and R6 are received by the system 11, they are sent to the appropriate agent for online learning.

In some embodiments, at step 207, in-window rewards are collated with other in-window rewards received in respect of the same action. In an example of such embodiments applied to the situation shown in FIGS. 4A to 4D, rewards R2 and R4 would be collated together and rewards R3, R5 and R6 would be collated together for subsequent online use.

In some embodiments, steps 206 and 207 could be combined such that in-window rewards are immediately sent to the appropriate agent 23 for online learning and in-window rewards are collated with other in-window rewards received in respect of the same action. In an example of such embodiments applied to the situation shown in FIGS. 4A to 4D, as soon as rewards R1, R2, R5, R4, R4, and R6 are received by the system 11, they are sent to the appropriate agent for online learning and rewards R2 and R4 would be collated together and rewards R3, R5 and R6 would be collated together for subsequent online use.

A significant technical advantage associated with embodiments in which steps 206 and 207 are combined is that they provide increased flexibility in terms of how learning agents 23 can process rewards. For example, when all in-window rewards are collated via consecutive execution of step 207, this provides more flexibility to learning agents 23 in respect to how they deal with the in-window rewards they received at step 206. One notable example of this is the possibility of learning agents 23 to ignore some in-window rewards received via step 206, while processing other immediately. In such situations, a learning agent 23 may ignore relatively unimportant in-window rewards (e.g., in-window rewards having a weighting lower than a certain value) received via step 206, while immediately processing relatively important in-window rewards (e.g., in-window rewards having a weighting higher than a certain value) received via step 206 immediately. Because the relatively unimportant in-window rewards will also be collated via step 207, the agent can also receive reward information (conveying information relating to the relatively unimportant in-window rewards) once the associated action is considered to no longer be in the fixed length sliding window 401. Accordingly, learning agents 23 can use part or all of the rewards received via step 206, as well as collated reward information received at step 207, as described in more detail herein. As such, the methods and systems described herein allow for significantly more flexible and efficient processing of rewards by learning agents 23. Other technical advantages associated with this embodiment will be understood by the skilled reader.

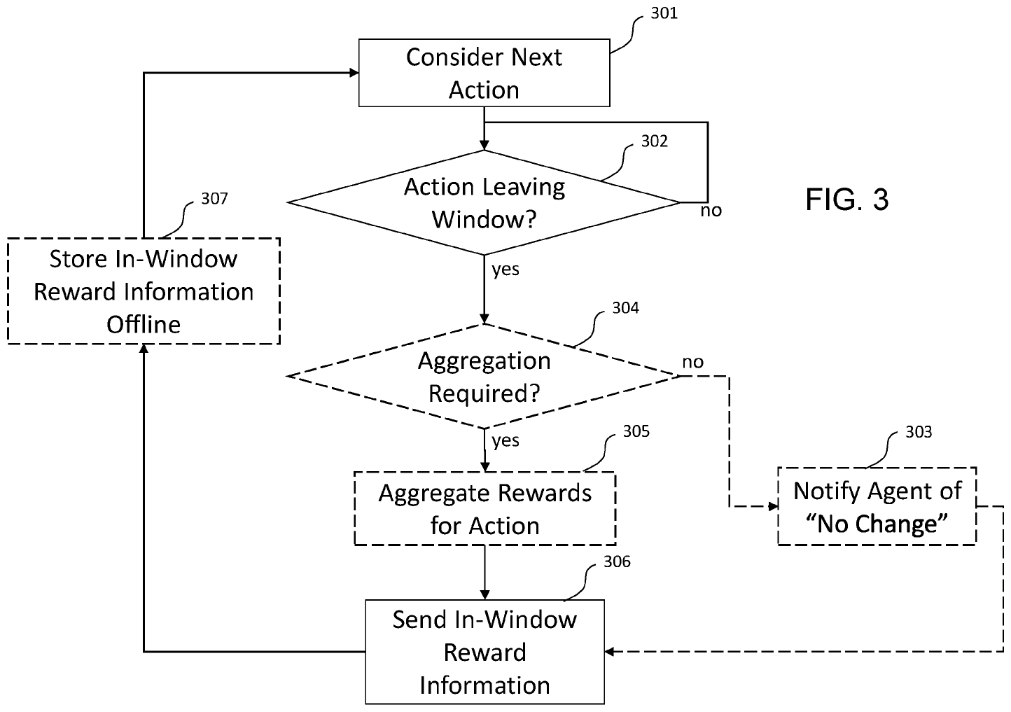

With reference to FIGS. 3 and 4A to 4D, an example of a method for processing retroactive rewards from one or more human evaluators 61 during live learning sessions in accordance with the present disclosure will now be described.

FIG. 3 shows flow-chart of a method for consolidating rewards in accordance with embodiments of the present disclosure. As shown in FIG. 3, at step 301, the system 10 processes an action to determine whether consolidated reward information should be sent to the learning agent 23 that performed the action. At step 302, a determination is made as to whether the action being considered is leaving the fixed length sliding window 401 (e.g., whether it is sliding out the trailing edge of fixed length sliding window 401). If the action is not leaving the fixed length sliding window 401, the system will wait until the action slides out of the fixed length sliding window 401.

In some embodiments, for example those in which online collation step 207 were performed during the collection stage shown in FIG. 2, once an action has been determined to have left (or is leaving) the fixed length sliding window 401, a determination is made at step 304 as to whether aggregation of the collated online in-window rewards is required. In an example of such embodiments applied to the situation shown in FIGS. 4A to 4D, as shown in FIG. 4D, action A2 is determined to be leaving the fixed length sliding window 401 at step t+8.

In some embodiments, where the system 10 has determined that the agent has processed all of the in-window rewards received for a specific action, a determination of “no change” can be incorporated into the in-window reward information at step 303 and sent to the appropriate learning agent 23 at step 306. As will be appreciated, such a “no change” determination can provide an indication to the agent that no in-window rewards remain unprocessed. In an example of such embodiments applied to the situation shown in FIGS. 4A to 4D, as shown in FIG. 4D, action A2 is determined to be leaving the fixed length sliding window 401 at step t+8. If rewards R3, R5 and R6 were received and immediately sent to the appropriate learning agent 23 in accordance with step 206, above, no further useful information can be provided to the appropriate agent by aggregating the values of R3, R5 and R6. As such, as determination of “no change” can be incorporated into the in-window reward information at step 306 and sent to the appropriate learning agent 23.

If, at step 304, a determination is made by the system 10 that an aggregation of the in-window rewards is required, then the system can aggregate the in-window rewards at step 305. Aggregation of rewards at step 305 can included aggregating all of the online in-window rewards collated at step 207 during the collection stage described with reference to FIG. 2, herein. Aggregation can include, but is not limited to, addition of all of the values of the online in-window rewards collated at step 207, an average value of the online in-window rewards collated at step 207 and/or a weighted average value of the online in-window rewards collated at step 207. As will be appreciated by the skilled reader, any other suitable methods of aggregating rewards can be used within the scope of the methods and systems described herein. In an example of such embodiments applied to the situation shown in FIGS. 4A to 4D, at time t+8, the system can aggregate the values of rewards R3, R5 and R6 and incorporate that aggregated value into the in-window reward information and sent to the appropriate learning agent 23.

Then, at step 306, the aggregated value of the online in-window rewards collated at step 207 can be incorporated into the in-window reward information and sent to the appropriate learning agent 23, before the system goes on to consider the next action in the sequence at step 301. As will be appreciated by the skilled reader, in accordance with such embodiments, because the aggregate in-window reward information is being sent to the learning agent 23, the learning agent 23 can incorporate fewer than all of the in-window rewards received via step 206 above. This is a significant technical advantage associated with the methods and systems described herein.

In some embodiments, the in-window reward information sent to the appropriate learning agent at step 306 is also stored in the offline database at step 307 for use in offline training.

In accordance with another exemplary implementation of the methods and systems described herein, the simulation environment 11 can be a flight simulation program in which a plurality of learning agents 23 pilot drones towards a specific destination, and a plurality of human evaluators 61 provide rewards to the learning agents 23 based on each human evaluator's 61 evaluation of flight maneuvers performed by the learning agents 23.

Each human evaluator 61 thus reacts and analyses actions performed by the learning agents 23, and then provides rewards with a reaction time delay ranging from a fraction of a second, to several seconds from the performance of the action (i.e., the flight maneuver). In the context of online training, a learning agent 23 will continue to take action and perform flight maneuvers without knowing if a past action will receive a reward. Prior to starting the simulation environment 11, a system operator, which can be a human evaluator 61 in some embodiments, can interact with the system to set the length of the fixed length sliding window 401, based on an understanding of the maximum delay acceptable between an action and a reward to achieve a target learning performance of the learning agents 23 and/or information based relating to the reaction times of the human evaluators 61. In other embodiments, the length of the fixed length sliding window can be set and/or reset during a learning session, based on the nature and identity of the entities providing feedback. For example, some human evaluators 61 may be known to provide rewards with a much slower reaction time than other human evaluators 61 but may not participate in the entire learning session. As such, the system 10 itself may shorten the length of the fixed length sliding window at some point during the learning session when the slower human evaluator 61 has ceased to participate in the learning session. Other examples of how the system 10 and/or a human operator can set and/or reset the length of the fixed length sliding window will be understood by those skilled in the art.

In the example shown in FIGS. 4A to 4D, the length of the fixed length sliding window 401 can be set so that the leading edge is a zero seconds from the clock of the system 10, and the trailing edge could be set at five seconds from the clock of the system 10, because the system operator understands that, given the speed of advancement of the simulation, a reward received by a learning agent 23 more than five seconds after the occurrence of the action corresponding to the reward, will not be useful to learning agent 23 for the process of online learning, but may still be useful for subsequent offline learning.

Conventional techniques related to implementing and using aspects of the systems and methods described herein may not be described in detail herein. In particular, various aspects of computing systems and specific computer programs that can be used to implement the various technical features described herein are well known. Accordingly, in the interest of brevity, many conventional implementation details are only mentioned briefly herein or are omitted entirely.

Moreover, it is to be understood that although this disclosure includes a reference to cloud computing, implementation of the teachings recited herein are not limited to a cloud computing environment. Rather, embodiments of the methods and systems disclosed herein are capable of being implemented in conjunction with any other type of computing environment now known or later developed.

Moreover, a person of skill in the art will readily recognize that steps of various aforementioned methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The description and drawings merely illustrate the principles of the invention. It will thus be appreciated that those skilled in the art will be able to devise various arrangements that, although not explicitly described or shown herein, embody the principles of the invention and are included within the scope of the appended claims. Furthermore, all examples recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

It should be appreciated by those skilled in the art that any block diagrams herein represent conceptual views of illustrative software and/or circuitry embodying the principles of the invention. Similarly, it will be appreciated that any flow charts, flow diagrams, state transition diagrams, pseudo code, and the like represent various processes which may be substantially represented in computer readable medium and so executed by a computer or processor whether or not such computer or processor is explicitly shown.

1. A computer implemented method for processing rewards received during a reinforcement learning session in which one or more learning agents each perform one or more actions in a reinforcement-type machine learning environment, each reward being associated with an action, the method comprising the steps of:
setting a fixed length sliding window within which past actions are considered;
receiving a plurality of rewards, each reward being associated with an action taken by a learning agent;
defining a group of in-window rewards comprising rewards received while their associated actions are considered to be within the fixed length sliding window; and
when an action performed by a learning agent is no longer considered to be within the fixed length sliding window, sending the learning agent reward information relating to all in-window rewards received for the action.

2. The computer implemented method of claim 1, wherein each in-window reward includes a value associated with a critical assessment of the action associated with the reward, and the reward information relating to all in-window rewards received for the action includes information associated to an aggregate of the values of the in-window rewards.

3. The computer implemented method of claim 1, wherein the method further comprises the step of:
sending each in-window reward, associated with an action performed by a learning agent, to the learning agent as soon as it is received.

4. The computer implemented method of claim 3, wherein the reward information relating to all in-window rewards received for the action includes an indication that all the rewards associated with the action have been received by the learning agent.

5. The computer implemented method of claim 3, wherein the learning agent is configured to use less than all of the rewards received as a result of the sending step for reinforcement-type machine learning.

6. The computer implemented method of claim 1, wherein the fixed length sliding window is implemented using a fixed length of time.

7. The computer implemented method of claim 6, wherein the fixed length of time comprises a linear period of time and the fixed length sliding window is implemented as a timer.

8. The computer implemented method of claim 6, wherein the fixed length of time comprises a fixed number of discrete steps associated with the implementation of the reinforcement-type machine learning environment.

9. The computer implemented method of claim 1, wherein the fixed length sliding window is implemented using a circular memory buffer.

10. The computer implemented method of claim 1, wherein rewards comprise an assessment of the action associated with the reward.

11. The computer implemented method of claim 10, wherein the assessment of the action associated with the reward can be a positive, negative or neutral assessment.

12. The computer implemented method of claim 11, wherein rewards comprise a numerical value representing the positive, negative or neutral assessment of the action associated with the reward.

13. The computer implemented method of claim 1, wherein rewards are generated by one or more human evaluators.

14. The computer implemented method of claim 1, wherein rewards are generated by one or more other learning agents.

15. The computer implemented method of claim 14, wherein the values of rewards are weighted differently depending on which of the one or more human evaluators and one or more other learning agents generated the rewards.

16. A system for processing rewards received during a reinforcement learning session in which one or more learning agents each perform one or more actions in a reinforcement-type machine learning environment, each reward being associated with an action, the system comprising:
a processor; and
at least one non-transitory memory containing instructions which when executed by the processor cause the system to
carry out the method of claim 1.

17.-30. (canceled)
